(19) United States
(12) Patent Application Publication
(10) Pub. No.: US 2023/0188196 A1
(43) Pub. Date: Jun. 15, 2023

(54) BEAM CONFIGURATION FOR ACCESSING AN OPEN SPECTRUM

(71) Applicant: Sony Group Corporation, Tokyo (JP)

(72) Inventors: Olof ZANDER, Södra Sandby (SE); Jose FLORDELIS, Lund (SE); Erik BENGTSSON, Eslöv (SE); Fredrik RUSEK, Eslöv (SE); Kun ZHAO, Malmö (SE)

(21) Appl. No.: 18/015,701

(22) PCT Filed: Jul. 27, 2021
(86) PCT No.: PCT/EP2021/070999

§ 371 Date: Jan. 11, 2023

(30) Foreign Application Priority Data
Aug. 7, 2020 (SE) 2030247-7

(51) Int. Cl. H04B 7/06; H04B 7/08; H04W 74/08

(52) U.S. Cl. CPC H04B 7/0695; H04B 7/088; H04B 7/0632; H04W 74/0808

(57) ABSTRACT

A method of operating a first node (91, 101) of a communications network (100), the method comprising: transmitting, to at least one second node (92, 102), at least one beam configuration (200, 4050) of a listen-before-talk procedure for accessing an open spectrum (481) by the at least one second node (92, 102).

### TECHNICAL FIELD

Various examples generally relate to using beamforming for accessing an open spectrum using a listen-before-talk procedure. Various examples specifically relate to determining a beam configuration for the listen-before-talk procedure.

### BACKGROUND

The spectral efficiency of wireless communication on an open spectrum can be enhanced. Multiple operators or networks may share access to the open spectrum. In other words, access to the open spectrum may not be restricted to a single operator or network. There may not be a central scheduling for all nodes accessing the open spectrum. Thus, there is a risk of collision between two nodes that try to contemporaneously access the open spectrum.

To avoid such collisions, the wireless communication on the open spectrum typically includes collision-mitigation procedures. Such techniques may include, but are not limited to a listen-before-talk (LBT) procedure. The LBT procedure implements a clear channel assessment. The LBT procedure requires a node intending to access the open spectrum to monitor the open spectrum before transmitting, to thereby find out whether or not other nodes are currently accessing the open spectrum. The positive or negative outcome of the LBT procedure typically depends on the traffic density on the open spectrum. For example, if one or more other nodes are currently accessing the open spectrum, then the open spectrum may not be able to accommodate further nodes accessing the open spectrum and the LBT procedure yields a negative outcome. Thus, the channel access on the open spectrum is generally limited or, at least, a priori uncertain. On the other hand, if the LBT procedure yields a positive outcome, the node can access the spectrum.

Wireless communication can be implemented in a spatially directive manner. For this, a spatial data stream can be defined by focusing the transmission energy for transmitting (transmit beam, TX beam) and/or the receive sensitivity for receiving (receive beam, RX beam) to a particular spatial direction. This is referred to as beamforming.

In a scenario in which beamforming is used for the LBT procedure, the chance of the LBT procedure yielding a positive outcome is known to show a dependency on the respective beam configuration. Furthermore, it has been found that a likelihood of false positive outcomes and/or a likelihood of false negative outcomes of the LBT procedure can show a dependency on the respective beam configuration.

### SUMMARY

Accordingly, there is a need for advanced techniques of determining a beam configuration for LBT procedures for accessing an open spectrum.

This need is met by the features of the independent claims. The features of the dependent claims define examples.

A method of operating a first node of a communications network includes transmitting at least one beam configuration to at least one second node. The beam configuration is for an LBT procedure that is for accessing an open spectrum by the at least one second node.

A computer program or a computer-program product or a computer-readable storage medium includes program code. The program code can be loaded and executed by at least one processor. Upon loading and executing the program code, the at least one processor transmits at least one beam configuration to at least one second node. The beam configuration is for an LBT procedure. The LBT procedure is for accessing the open spectrum by the at least one second node.

A first node of a communications network includes control circuitry. The control circuitry is configured to transmit at least one beam configuration to at least one second node. The beam configuration is for an LBT procedure. The LBT procedure is for accessing the open spectrum by the at least one second node.

A method of operating a second node includes receiving a beam configuration. The beam configuration is received from a first node of a communications network. The beam configuration is for a LBT procedure for accessing an open spectrum. The method also includes attempting to access the open spectrum using the LBT procedure. The LBT procedure then uses the beam configuration.

A computer program or a computer-program product or a computer-readable storage medium includes program code. The program code can be loaded and executed by at least one processor. Upon loading and executing the program code, the at least one processor receives a beam configuration of a LBT procedure for accessing an open spectrum. The beam configuration is received from a first node of a communications network. The at least one processor further attempts to access the open spectrum using the LBT procedure using the beam configuration.

A second node includes control circuitry. The second node may be part of a communications network. The second node could also be connected to the communications network. The control circuitry is configured to receive, from a first node of the communications network, a beam configuration of a LBT procedure for accessing an open spectrum. The control circuitry is further configured to attempt to access the open spectrum using the LBT procedure using the beam configuration.

A method of operating a node includes measuring an energy on an open spectrum. The method also includes transmitting a measurement report that is indicative of the energy to a further node.

A computer program or a computer-program product or a computer-readable storage medium includes program code. The program code can be loaded and executed by at least one processor. Upon loading and executing the program code, the at least one processor or measures and energy on an open spectrum and transmits a measurement report that is indicative of the energy to a further node.

A node includes control circuitry. The node may be part of a communications network. The node could also be connected to the communications network. The control circuitry is configured to measure and energy on an open spectrum and to transmit a measurement report indicative of the energy to a further node. The further node can be part of the communications network or can be connected to the communications network.

A method of operating a first node of a communications network includes receiving a measurement report from at least one second node. The at least one second node may be part of the communications network or may be connected to the communications network. The measurement report may be indicative of an energy on an open spectrum or another measured quantity. The energy on the open spectrum or the other quantity is measured on the open spectrum by the at least one second node. The method also includes determining a beam configuration for a LBT procedure for accessing the open spectrum based on the measurement report. The method further includes attempting to access the open spectrum using the LBT procedure using the beam configuration.

A computer program or a computer-program product or a computer-readable storage medium includes program code. The program code can be loaded and executed by at least one processor. Upon loading and executing the program code, the at least one processor receives a measurement report from at least one second node. The at least one second node may be part of the communications network or may be connected to the communications network. The measurement report is indicative of an energy on an open spectrum. The energy on the open spectrum is measured by the at least one second node. The at least one processor also determines a beam configuration for an LBT procedure for accessing the open spectrum based on the measurement report and attempts to access the open spectrum using the LBT procedure using the beam configuration.

A first node of a communications network includes control circuitry. The control circuitry is configured to receive a measurement report from at least one second node. The measurement report is indicative of an energy on an open spectrum. The energy on the open spectrum is measured by the at least one second node. The control circuitry is also configured to determine a beam configuration for an LBT procedure for accessing the open spectrum based on the measurement report and to attempt to access the open spectrum using the LBT procedure using the beam configuration.

It is to be understood that the features mentioned above and those yet to be explained below may be used not only in the respective combinations indicated, but also in other combinations or in isolation.

### BRIEF DESCRIPTION OF THE DRAWINGS

FIG. 1 schematically illustrates a communication system according to various examples.

FIG. 2 schematically illustrates a communication system according to various examples.

FIG. 3 schematically illustrates a cellular network according to various examples.

FIG. 4 illustrates multiple modes in which a wireless communication device can operate with respect to a cellular network according to various examples.

FIG. 5 schematically illustrates multiple RX beams that can be used for an LBT procedure according to various examples.

FIG. 6 schematically illustrates multiple RX beams that can be used for an LBT procedure according to various examples.

FIG. 7 is a signaling diagram of communication between multiple nodes according to various examples.

FIG. 8 is a signaling diagram of communication between multiple nodes according to various examples.

FIG. 9 is a signaling diagram of communication between multiple nodes according to various examples.

FIG. 10 is a flowchart of a method according to various examples.

FIG. 11 is a flowchart of a method according to various examples.

FIG. 12 is a flowchart of a method according to various examples.

FIG. 13 is a flowchart of a method according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of wireless communication are described. Specifically, techniques are described which allow for wireless communication on an open spectrum. On the open spectrum, time-frequency resources are typically not centrally scheduled for all accessing nodes (albeit subgroups of nodes may use central scheduling). Therefore, a clear channel assessment (CCA), e.g., in the form of an LBT procedure, is employed to avoid collisions between multiple nodes attempting to access the open spectrum contemporaneously without central scheduling. There may not be a single operator in charge of allocating the time-frequency resources to the various nodes on the open spectrum. Nodes associated with multiple operators may access the open spectrum.

Various techniques can employ a cellular radio access technology for accessing the open spectrum. An example would be the Third Generation Partnership Project (3GPP) New Radio Unlicensed (NR-U) radio access technology (RAT). Various techniques are based on the finding that for NR-U, channel access mechanisms are needed to comply with the regulations imposed by a regulatory body for accessing the open spectrum (hence, sometimes the open spectrum is also referred to as unlicensed spectrum). For the CCA mechanism, an LBT procedure is adopted as a baseline, at least for a spectral band in which the absence of IEEE 802.11x Wi-Fi nodes accessing cannot be guaranteed, e.g., by regulatory constraints.

As a general rule, when implementing an LBT procedure, a node attempting to access the open spectrum can sense the channel by implementing a measurement of the detected energy (ED). For example, the ED may be expressed as dBm/Hz. For example, the ED may be measured in a spatially-resolved manner, e.g., using different RX beams. It would be possible that the ED is measured in a frequency-resolved manner, i.e., for different frequencies within the open spectrum. The ED can vary over the course of time and could thus be averaged across the LBT duration. A measurement of the ED may be different to, e.g., a measurement of the signal to interference and noise ratio (SINR) or the reference signal received power (RSRP). The RSRP or SINR are measured based on one or more receive properties such as amplitude and phase of specific reference signals—e.g., synchronization signals included in a synchronization signal block (SSB) or channel state information reference signals. Such reference signals are required to be configured by a scheduler, e.g., base station. Differently, the ED measured may be defined as the total energy over the bandwidth of the open spectrum observed during the duration of the LBT procedure and this can include both 3GPP and non-3GPP signals or generally signals of all further nodes accessing the open spectrum—in other words, the ED can be determined independent of the presence or absence of reference signals. Based on the ED, the presence or the absence of other signals on the open spectrum can be determined, i.e., a traffic density can be determined based on the ED, e.g., a change of the ED as a function of time. For instance, it would be possible to determine a long-term average of the ED as a baseline and then monitor short-term deviations from this long-term average. The short-term deviations can be indicative of the current traffic density. For example, if the detected ED during the initial LBT duration (sometimes also referred to as CCA duration) is lower than a certain threshold (sometimes referred to as energy detection threshold), the node can access the open spectrum for a predefined time duration referred to as the Channel Occupancy Time (COT).

As a general rule, different configurations of the LBT procedure are conceivable. For example, different configurations of the LBT procedure may be associated with different LBT durations. For example, a so-called “Category I” LBT procedure can be used according to which the media transmission is implemented after a short switching gap of, e.g., 16 microseconds. It would also be possible to implement a “Category II” LBT procedure without a random backoff time duration and using a deterministic LBT duration of a fixed length, e.g., 25 microseconds. A “Category III” LBT procedure can implement a random back-off duration with a contention window of fixed size. The LBT duration can be extended by drawing a random number within a fixed contention window. A “Category IV” LBT procedure can implement a random back-off duration with the contention window of variable size in which an extended LBT duration is drawn by a random number; the LBT duration can vary based on channel dynamics.

According to various examples, the LBT procedure can employ RX beamforming. As a general rule, beamforming can be implemented using an antenna array: here, multiple antennas are arranged in close vicinity and are driven in a well-defined relationship of the amplitudes and phases. The amplitude and phases with which different antennas of the antenna array contribute to the transmission is sometimes referred to as antenna weights or steering vectors or spatial precoding. Thereby, distinct spatial data streams can be implemented. Spatial multiplexing is possible.

A respective beam configuration may be determined for attempting to access the open spectrum using the LBT procedure. The ED can be measured using one or more RX beams. Various beam configurations for the LBT procedure are summarized below in TAB. 1.

TABLE 1
example beam configurations for an LBT procedure
for accessing the open spectrum.

| Example | Brief description | Details |
|---|---|---|
| A | No beamforming | No spatial precoding is used. For example, |
| | | only a single antenna element of an antenna |
| | | array may be used to measure the ED on the |
| | | open spectrum. |
| B | Omnidirectional | One or more beams are selected so as to |
| | beamforming | implement a maximum LBT angle for performing |
| | | the ED measurements on the open spectrum. |
| | | As a general rule, “omnidirectional” may not |
| | | necessarily imply a 360° LBT angle, but e.g., |
| | | an LBT angle that is not smaller than 300°. In |
| | | some examples, the operation of the UE for |
| | | example B may be the same as the operation of |
| | | the UE for example A. |
| C | directional beamforming, | A single beam or few beams can be selected |
| | e.g., unidirectional | so as to implement a narrow LBT angle |
| | beamforming | according to the beamwidth of that selected beam(s). |
| | | For example, a pencil beam having a comparably |
| | | narrow beamwidth can be used. This is |
| | | significantly smaller than the LBT angle |
| | | according to example B, omnidirectional |
| | | beamforming. Where multiple beams are selected, |
| | | these can be sequentially activated at different |
| | | points in time. |
| | | This facilitates limitation of the LBT procedure |
| | | to a comparably small count of RX beams. This |
| | | has the effect of being able to conclude the |
| | | LBT procedure within a comparably short time |
| | | duration, e.g., if compared to the omnidirectional |
| | | beam configuration of example B, in particular |
| | | where the UE as to implement a sequential |
| | | beam sweep, e.g., due to analog beamforming. |
| D | Multidirectional | Multiple beams may be selected so as to |
| | beamforming | implement an LBT angle in-between example B - |
| | | omnidirectional beamforming - and example C - |
| | | unidirectional beamforming. For illustration, it |
| | | would be possible that the beam configuration |
| | | is indicative of a subset of beams of a group of |
| | | beams that are generally available for RX |
| | | beamforming at the respective node. For |
| | | instance, where a total of 20 beams would be |
| | | available, the multidirectional beamforming |
| | | may employ a subset thereof, e.g., at least 2 |
| | | beams and at most 19 beams. Also, in such a |
| | | scenario, the time duration required to perform |
| | | the LBT procedure can be reduced, since the |
| | | count of beams to be sequentially switched to |
| | | is comparably limited. A balance/trade-off |
| | | between examples B and C can be achieved. |

A beam configuration according to TAB. 1 that employs multiple beams—e.g., as in the scenario of example B or D—may activate the multiple beams contemporaneously, e.g., a scenario sometimes referred to as digital beamforming (or hybrid beamforming). Here, multiple receiver chains can be available that can implement different antenna weights for the antenna elements of the antenna array, so as to be able to contemporaneously monitor multiple RX beams. Digital beamforming is different from analog beamforming. Here, only a single RX chain is available and different RX beams are activated sequentially, by appropriately setting the circuitry of the RX chain to implement respective antenna weights.

Hereinafter, the process of activating multiple beams will be referred to as a beam sweep, for both scenarios, i.e., digital beamforming and analog beamforming. The time required to implement a beam sweep is significantly longer for analog beamforming if compared to digital beamforming.

Various techniques are based on the finding that determining the appropriate beam configuration according to TAB. 1 can be helpful when attempting to access the open spectrum. Two scenarios are illustrated in TAB. 2 below.

TABLE 2
Summary of the impact of the beam configuration used for the LBT procedure on
subsequent communication on the open spectrum. In a scenario in which a beam
sweeps used, the total spatial angle covered by all beams of the beam sweep is
referred to as LBT angle (for an RX beam sweep). For example, where four similar
beams next to each other are used, then the LBT angle is approximately four times
larger than opening angle of each of these beams. Where only a single RX beam
is used, the LBT angle corresponds to the opening angle of this beam.

| Example | Brief description | Details |
|---|---|---|
| A | LBT angle too wide | Where a LBT angle is used that is too wide |
| | | (e.g., as may be the case in TAB. 1, example |
| | | B or example D), a so-called exposed node |
| | | problem can result. Here, the potential for |
| | | collision may be overestimated, i.e., due to the |
| | | wide LBT angle, a comparably high traffic density |
| | | may be assumed. Nonetheless, since the |
| | | various nodes accessing the open spectrum |
| | | transmit using TX beamforming - e.g., as |
| | | would be typical in high frequency ranges, e.g., |
| | | at or above 40 GHz - spatial multiplexing can |
| | | efficiently reduce collision. |
| | | In other words, such overestimation of the potential |
| | | for collision can describe a situation in |
| | | which a node senses the open spectrum as being |
| | | busy (e.g., because it listens to an ongoing |
| | | transmission), but in fact it could have |
| | | transmitted by accessing the open spectrum |
| | | simultaneously with that ongoing transmission |
| | | without creating any collision. Thereby, the chance |
| | | for nodes to access the open spectrum is reduced, |
| | | in particular when the traffic density is high. |
| B | LBT angle to narrow | If the LBT angle used is too narrow (e.g., as |
| | | may be the case in TAB. 1, example C), a so- |
| | | called hidden node problem can result. Here, |
| | | the potential for collision may be underestimated, |
| | | i.e., due to the narrow LBT angle, a |
| | | comparably small traffic density may be assumed. |
| | | Nonetheless, when actually accessing |
| | | open spectrum, there may be a collision |
| | | resulting from another node that has not been |
| | | detected when attempting to access the open |
| | | spectrum by the LBT procedure. |

Various techniques are based on the finding that, to appropriately address the trade-off situation between example A and example B according to TAB. 2, it can be helpful to accurately determine the traffic density on the open spectrum. Various techniques help to accurately determine a beam configuration for the LBT procedure so that collisions are avoided and, on the other hand, the success rate of the LBT procedure yielding a positive outcome is not undermined.

In further detail, it has been observed that a category I LBT procedure can lead to collisions with non-3GPP radio access technologies such as IEEE 802.11x; the category II LBT procedure is more commonly used for random access signaling when transitioning to a connected mode and transmission of control messages due to a long delay; and category III or category IV LBT procedures can be used for transmission of payload data. Since the switching gap between uplink communication and downlink communication or vice versa includes the LBT duration, a significant time gap between downlink communication and uplink communication can result. This is particularly true, where a wide LBT angle is implemented by the beam configuration for the LBT procedure, because (at least for analog beamforming), it may then be required to consecutively switch between multiple RX beams to implement the wide LBT angle. Thus, a situation can result where even for size limited and/or urgent data a long LBT procedure, e.g., according to category IV, is required. According to the techniques described herein, it is possible to determine the beam configuration so as to avoid an overly long LBT procedure, while not compromising accuracy in the determining of the traffic density on the open spectrum.

According to techniques described herein, such and further effects may be achieved by a first node of a communications network providing, to a second node of the communications network, the beam configuration for the LBT procedure for accessing the open spectrum by the second node. The first node can transmit the beam configuration and the second node can receive the beam configuration. For example, the first node could be an access node of a radio access network (RAN) of a cellular network (NW), e.g., a base station. The RAN could then remote-control the beam configuration for a wireless communication device (UE), implementing the second node. The second node can then attempt to access the open spectrum using the received beam configuration.

Such techniques are based on the finding that oftentimes the particular node attempting to access the open spectrum by performing the LBT procedure may suffer from having incomplete information regarding the traffic density on the open spectrum. Therefore, according to the techniques described herein, another node can remote-control the beam configuration for the LBT procedure. Then, the appropriate trade-off between the scenarios A and B of TAB. 2 can be implemented.

More generally, it would be possible that a first node transmits, to one or more second nodes, at least one beam configuration of the LBT procedure for accessing the open spectrum by the at least one second node.

For example, it would be possible that the at least one beam configuration is transmitted to multiple second nodes that are located at different positions with respect to the first node. In other words, multiple second nodes may be located at different areas around the first node. Therefore, different spatial streams may be used for the communication between each one of the multiple second nodes and the first node. In view of such spatial multiplexing, different beam configurations can be determined and transmitted to different second nodes. I.e., it would be possible to use different beam configurations for different UEs, depending on a particular position of the UE.

Then, the appropriate trade-off between the scenarios A and B of TAB. 2 can be implemented for each of the multiple second nodes.

According to further examples, to determine the beam configuration for the LBT procedure for accessing the open spectrum can be based on additional information that can be communicated and that is helpful to accurately assess the traffic density on the open spectrum. For instance, the beam configuration can be more accurately determined, e.g., to tailor the trade-off between scenarios A and B according to TAB. 2.

According to examples, it would be possible that a first node receives, from at least one second node, a measurement report indicative of an ED of an open spectrum measured by the at least one second node. Then, the beam configuration for the LBT procedure can be determined based on the measurement report. The first node can then attempt to access the open spectrum using the LBT procedure using the beam configuration.

By such techniques, the appropriate beam configuration for attempting to access the open spectrum using the LBT procedure can be accurately determined. For example, the beam configuration can be repeatedly adjusted over the course of time, as the traffic density on the open spectrum is subject to temporal variation. Such beam adaptation is thereby improved. The first node—e.g., a base station of a RAN—can optimize the beam adjustment in the operation on the open spectrum.

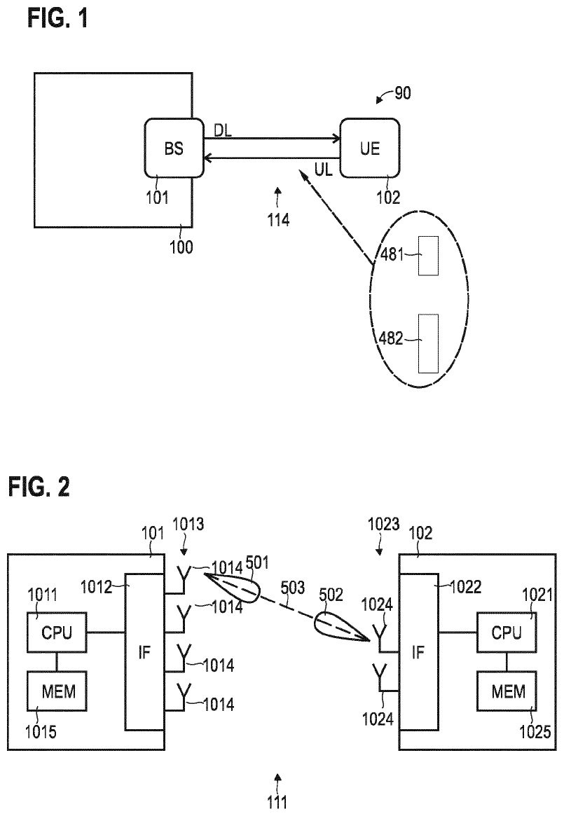

FIG. 1 schematically illustrates a wireless communication system 90 that may benefit from the techniques disclosed herein. The wireless communication system 90 includes a UE 102 and a base station (BS) 101 of a RAN of a cellular NW 100.

As a general rule, the techniques described herein may be applicable to cellular NWs of various kinds and types. For instance, the cellular NW 100 may be a 3GPP-standardized cellular NW such as 4G Long Term Evolution (LTE) or 5G NR.

A wireless link 114 is established between the BS 101 and the UE 102. Downlink communication is implemented from the BS 101 to the UE 102. Uplink communication is implemented from the UE 102 to the BS 101.

The wireless link 114 is at least partly implemented on an open spectrum 481 (see circular inset in FIG. 1). I.e., a carrier and/or multiple subcarriers of the wireless link 114 can reside on the open spectrum 481. Optionally, a further part of the wireless link 114 may be implemented on a dedicated spectrum 482 (sometimes referred to as licensed spectrum). The dedicated spectrum 482 may be fully controlled by the NW operator of the cellular NW 100. Differently, the open spectrum 481 may be accessible by further nodes not controlled by the NW operator of the cellular NW.

The UE 102 may be one of the following: a smart phone; a cellular phone; a tablet PC; a notebook; a computer; a smart TV; a machine type communication device; an IOT device; etc.

Further details of the BS 101 and the UE 102 are explained in connection with FIG. 2.

FIG. 2 illustrates details with respect to the BS 101. The BS 101 includes control circuitry that is implemented by a processor 1011 and a non-volatile memory 1015. The processor 1011 can load program code that is stored in the memory 1015. The processor 1011 can then execute the program code. Executing the program code causes the processor to perform techniques as described herein, e.g.: determining a beam configuration for an LBT procedure for accessing an open spectrum by the BS 101, e.g. based on a measurement of the ED on the open spectrum executed by the BS 101, the UE 102, and/or another UE; determining a beam configuration for an LBT procedure for accessing an open spectrum by the UE 102; transmitting the beam configuration for the LBT procedure for accessing the open spectrum by the UE 102 to the UE 102; receiving, from the UE 102 or another UE, a measurement report indicative of an ED on the open spectrum; etc.

FIG. 2 also illustrates details with respect to the UE 102. The UE 102 includes control circuitry that is implemented by a processor 1021 and a non-volatile memory 1025. The processor 1021 can load program code that is stored in the memory 1025. The processor can execute the program code. Executing the program code causes the processor to perform techniques as described herein, e.g.: receiving a beam configuration for an LBT procedure for accessing an open spectrum from the BS 101; attempting to access the open spectrum using the LBT procedure using the beam configuration as obtained from the BS 101; transmitting to the BS 101 a measurement report indicative of an ED on the open spectrum is measured by the UE 102; etc.

FIG. 2 also illustrates details with respect to communication between the BS 101 and the UE 102 on the wireless link 114. The BS 101 includes an interface 1012 that can access and control multiple antennas 1014. Likewise, the UE 102 includes an interface 1022 that can access and control multiple antennas 1024.

While the scenario of FIG. 2 illustrates the antennas 1014 being coupled to the BS 101, as a general rule, it would be possible to employ transmit-receive points (TRPs) that are spaced apart from the BS.

The interfaces 1012, 1022 can each include one or more TX chains and or more RX chains. For instance, such RX chains can include low noise amplifiers, analogue to digital converters, mixers, etc. Analog and/or digital beamforming would be possible.

Thereby, phase-coherent transmitting and/or receiving (communicating) can be implemented across the multiple antennas 1014, 1024. Thereby, the BS 101 and the UE 102 implement a multiple-input multiple-output (MIMO) communication system.

As a general rule, the receiver of the MIMO communication system receives a signal y that is obtained from an input signal x multiplied by a transmission matrix H.

The transmission matrix H defines the channel transfer function at a certain subcarrier of an OFDM system of the wireless link 114. The rank of the transmission matrix corresponds to the number of linearly independent rows or columns and, as such, indicates how many independent data streams can be used simultaneously; this is sometimes referred to as the number of layers. The rank can be different for different MIMO transmission modes. For MIMO transmission modes, the amplitude and/or phase (antenna weights) of each one of the antennas 1014, 1024 is appropriately controlled by the interfaces 1012, 1022.

For instance, one possible transmission mode can be a diversity MIMO transmission mode.

Another MIMO transmission mode is spatial multiplexing. Spatial multiplexing enables an increase to the data rate if compared to a reference scenario in which a single data stream of similar throughput is used. The data is divided into different spatial streams and these different data streams can be transmitted contemporaneously over the wireless link 114.

The diversity MIMO transmission mode and the spatial multiplexing multi-antenna transmission mode can be described as using multiple beams, the beams defining the spatial data streams. These modes are, therefore, also referred to as multi-beam operation. By using a beam, the direction of the wavefront of signals transmitted by a transmitter of the communication system is controlled. Energy is focused into a respective direction, by phase-coherent superposition of the individual signals originating from each antenna 1014, 1024. Thereby, the spatial stream can be directed. The spatial streams transmitted on multiple TX beams can be independent, resulting in spatial multiplexing multi-antenna transmission; or dependent on each other, e.g., redundant, resulting in diversity MIMO transmission.

As a general rule, alternatively or additionally to such TX beams, it is possible to employ RX beams. In particular, one or more of such RX beams of a multi-antenna operation can be used as part of an LBT procedure when attempting to access an open spectrum. Here, a traffic density on the open spectrum can be determined by monitoring for signals on the open spectrum using one or more RX beams.

FIG. 2 illustrates two beams 501-502 and an associated spatial stream 503. Based on the assumption of beam reciprocity, each TX beam can be associated with an associated RX beam that has corresponding spatial characteristics (and vice versa).

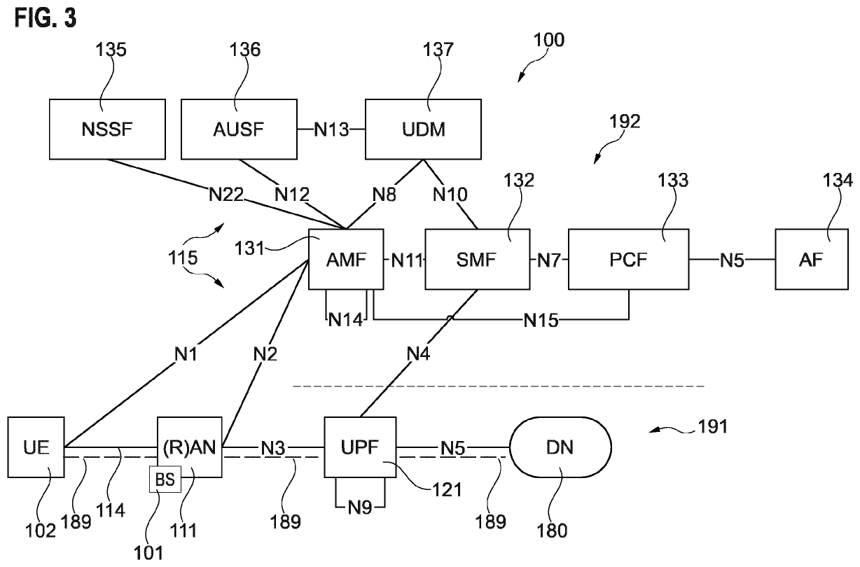

FIG. 3 schematically illustrates an example implementation of the cellular NW 100 in greater detail. The example of FIG. 3 illustrates a cellular NW 100 according to the 3GPP 5G architecture. Details of the fundamental architecture are described in 3GPP TS 23.501, version 1.3.0 (2017 September). While FIG. 3 and further parts of the following description illustrate techniques in the 3GPP 5G framework, similar techniques may be readily applied to different communication protocols. Examples include 3GPP LTE 4G and IEEE Wi-Fi technology.

The UE 102 is connectable to the cellular NW 100 via a RAN 111, typically formed by one or more BSs 101. The wireless link 114 is established between the RAN 111—specifically between one or more of the BSs 101 of the RAN 111—and the UE 102, thereby implementing the communication system 90 (cf. FIG. 1).

The RAN 111 is connected to a core NW (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 3, the UPF 121 acts as a gateway towards a data NW (DN) 180, e.g., the Internet or a Local Area NW. Application data can be communicated between the UE 102 and one or more servers on the DN 180.

The NW 100 also includes an Access and Mobility Management Function (AMF) 131; a Session Management Function (SMF) 132; a Policy Control Function (PCF) 133; an Application Function (AF) 134; a NW Slice Selection Function (NSSF) 134; an Authentication Server Function (AUSF) 136; and a Unified Data Management (UDM) 137. FIG. 3 also illustrates the protocol reference points N1-N22 between these nodes.

The AMF 131 provides one or more of the following functionalities: registration management; NAS termination; connection management; reachability management; mobility management; access authentication; and access authorization The AMF 131 may keep track of the timing of a DRX cycle of the UE 102. The AMF 131 may keep track of various NW registration modes in which the UE 102 can operate. The AMF 131 may trigger transmission of paging signals to the UE 102 by the BSs 101 of the RAN 111, e.g., in a tracking area to account for UE mobility.

A data connection 189 is established by the AMF 131 if the respective UE 102 operates in a connected mode. To keep track of the current NW registration mode of the UEs 102, the AMF 131 sets the UE 102 to Evolved Packet System Connection Management (ECM) connected or ECM idle. During ECM connected, a non-access stratum (NAS) connection is maintained between the UE 102 and the AMF 131. The NAS connection implements an example of a mobility control connection. The NAS connection may be set up in response to paging of the UE 102.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc.

FIG. 3 also illustrates aspects with respect to the data connection 189. The data connection 189 is established between the UE 102 via the RAN 111 and the UP 191 of the CN 115 and towards the DN 180. For example, a connection with the Internet or another packet data NW can be established. To establish the data connection 189, it is possible that the respective UE 102 performs a random access (RA) procedure (e.g., a 2-step or 4-step RA procedure), e.g., in response to reception of a paging signal. A server of the DN 180 may host a service for which application data (sometimes also referred to as payload data) is communicated via the data connection 189. The data connection 189 may include one or more bearers such as a dedicated bearer or a default bearer. The data connection 189 may be defined on the Radio Resource Control (RRC) layer, e.g., generally Layer 3 of the OSI model of Layer 2.

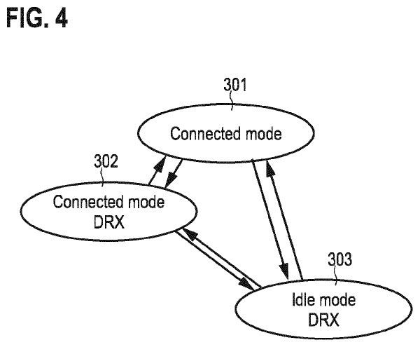

FIG. 4 illustrates aspects with respect to different NW operational modes 301-303 (also referred to as registration modes) in which the UE 102 can operate. Example implementations of the operational modes 301-303 are described, e.g., in 3GPP TS 38.300, e.g., version 15.0.

During connected mode 301, the data connection 189 is set up. For example, a default bearer and optionally one or more dedicated bearers may be set up between the UE 102 and the NW 100. The receiver of the UE 102 may persistently operate in an active state.

In order to reduce the power consumption, it is then possible to transition from the connected mode 301 to a further connected mode 302 which employs a DRX cycle of the receiver. The DRX cycle includes ON durations and OFF durations, according to a respective timing schedule. During the OFF durations, the receiver is unfit to receive data; an inactive state of the receiver may be activated. The data connection 189 is maintained set-up in mode 302.

To achieve a further power reduction, it is possible to implement an idle mode 303. The idle mode 303 is, again, associated with the DRX cycle of the receiver of the UE 102. However, during the on durations of the DRX cycle in idle mode 303, the receiver is only fit to receive paging indicators and, optionally, paging messages. For example, this may help to restrict the particular bandwidth that needs to be monitored by the receiver during the on durations of the DRX cycles in idle mode 303. The receiver may be unfit to receive application data. This may help to further reduce the power consumption—e.g., if compared to the further connected mode 302.

Various examples described herein pertain to operation of the UE 102 in the connected mode 301-302 or in the idle mode 303 employing the DRX cycle.

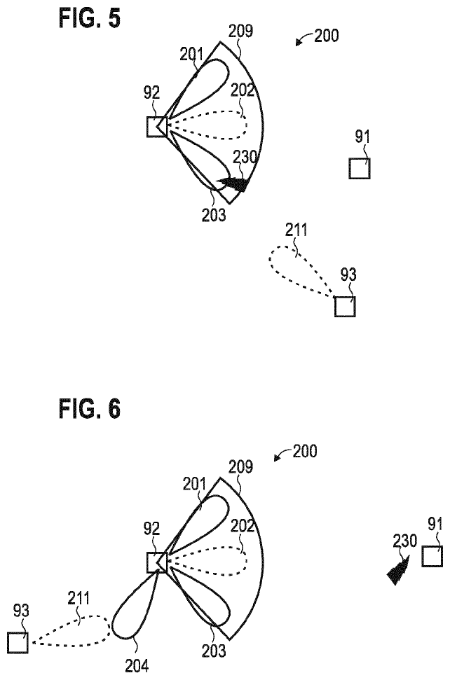

FIG. 5 illustrates aspects with respect to a node 92 attempting to transmit data to a node 91 on an open spectrum. For example, the node 92 could be implemented by the UE 102 and the node 91 could be implemented by the BS 101. It would also be possible that the node 91 is implemented by a further UE.

Before accessing the open spectrum, the node 92 performs an LBT procedure. Illustrated in FIG. 5 is a scenario in which the beam configuration 200 for being used when performing the LBT procedure defines a total of three beams 201-203; the respective LBT angle 209 is illustrated. There is interference 230 present on the open spectrum spatially restricted to the beam 203. There is no interference present on the open spectrum in spatial regions associated with the beams 201 and 202. Accordingly, the second node 92 would generally be able to access the open spectrum using a TX beam similarly shaped as the RX beam 202 to transmit to the node 91. In detail, the interference 230 is due to a node 93 transmitting using a TX beam 211 aligned with the RX beam 203. Accordingly, the LBT procedure yields a negative outcome, even though, in principle, access to the open spectrum would be possible using the TX beam corresponding to the RX beam 202. This corresponds to an exposed node problem, as discussed above in connection with TAB. 2: scenario A.

As will be appreciated from FIG. 5, performing a wide-angle or even omnidirectional LBT procedure can result in the exposed node problem. Furthermore, due to the requirement of implementing beam sweeping, a respective latency may be introduced, in particular for analog beamforming in which a switching between multiple RX beams is required. This can result in time gaps, e.g., between transmission of downlink data and the uplink data. According to the techniques described herein, it is possible to avoid such exposed node problem.

FIG. 6 illustrates aspects with respect to a node 92 attempting to transmit data to a node 91 on an open spectrum. For example, the node 92 could be implemented by the UE 102 and the node 91 could be implemented by the BS 101.

Before accessing the open spectrum, the node 92 performs an LBT procedure. Illustrated in FIG. 6 is a scenario in which the beam configuration 200 being used when performing the LBT procedure defines a total of three beams 201-203 (similar to the scenario of FIG. 5). However, in the scenario of FIG. 6, there is no interference 230 present on these beams 201-203. Accordingly, the LBT procedure yields a positive result and the node 92 accesses the open spectrum to transmit on the beam 202. In the scenario of FIG. 6, this causes interference 230 at the node 91 (receiver-side interference). This is because a node 93 transmits on the TX beam 211. Such interference from the node 93 would be visible to the node 92 when using a beam configuration for the LBT procedure including the beam 204, roughly directed towards the node 93. Accordingly, the LBT angle 209 associated with the beam configuration including the beams 201-203 used for the LBT procedure is too narrow. This corresponds to the hidden node problem according to TAB. 2: scenario B.

As will be appreciated from FIG. 6, performing an LBT procedure using a beam configuration 200 implementing a narrow LBT angle 209 can result in a hidden node problem. This can result in reduced communication reliability. According to the techniques described herein, it is possible to avoid such hidden node problem.

Further, as will be appreciated from a comparison of FIG. 5 and FIG. 6, one and the same beam configuration (here: beam configuration 200 including the beams 201-203) can in some scenarios result in the hidden node problem and in other scenarios result in the exposed node problem. Various techniques are based on the finding that it is not easily possible to predefine the beam configuration to be used for the LBT procedure. Accordingly, various techniques facilitate accurately determining the beam configuration, in particular in a dynamic manner depending on the particular interference situation observed on the open spectrum.

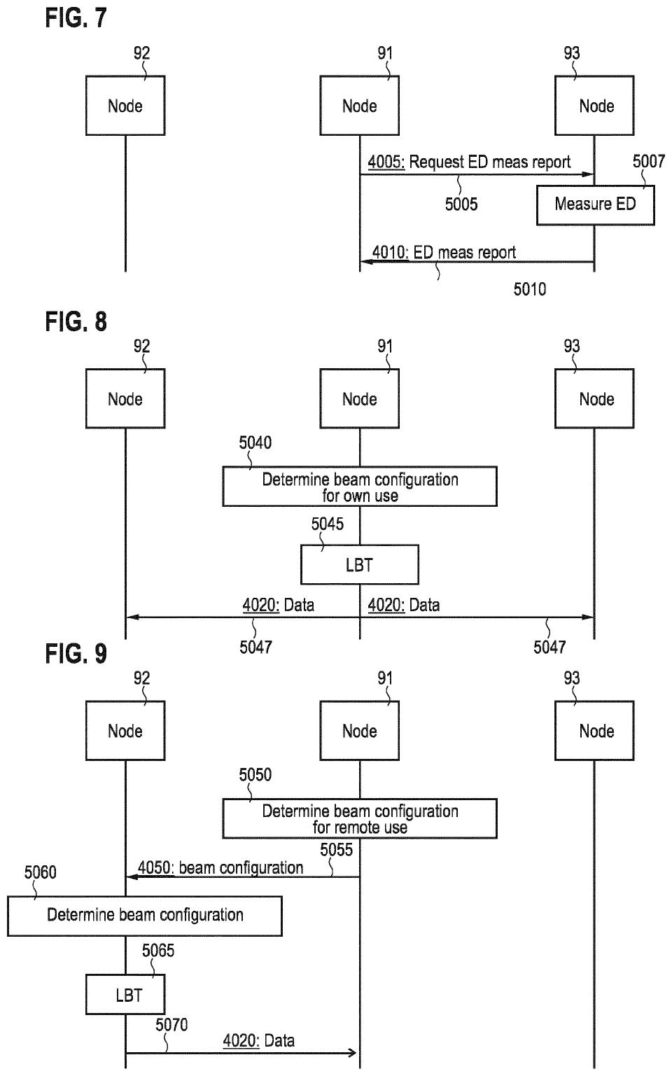

FIG. 7 is a signaling diagram of communication between multiple nodes 91 and 92. These are the nodes of FIG. 5 and FIG. 6. FIG. 7 illustrates techniques which facilitate accurately determining the beam configuration. In particular, FIG. 7 illustrates examples that facilitate obtaining additional information for determining the beam configuration.

At 5005, a node 91—e.g., a BS 101—requests, from a node 93—e.g., a UE such as the UE 102—a measurement report indicative of the ED on the open spectrum. For example, this could be an RRC configuration message transmitted to the node 93 when transitioning into the connected mode 301. It would also be possible that such request is transmitted on demand, e.g., while the node 93 operates in the connected mode 301. As a general rule, such explicit request is optional and it would be possible that the node 93 automatically transmits measurement reports indicative of the measured ED.

At 5007, the node 93 measures the ED. For instance, one or more RX beams can be used to sense the energy on the open spectrum 481.

At 5010, the node 93 transmits a measurement report 4010 that is indicative of the ED measured at 5007 on the open spectrum.

As a general rule, it would be possible that the measurement report is indicative of the ED on one or more frequency parts of the open spectrum. In other words, it would be possible that the total bandwidth of the open spectrum is structured into subparts and then the ED can be determined for these subparts, i.e., frequency-resolved. Such a frequency-resolved ED would enable to determine the traffic density and the frequency-resolved manner, as well. It would be possible to limit the LBT procedure to such subparts of the open spectrum that exhibit a tolerable traffic density that is comparably low.

As a further general rule, it would be possible that the measurement report is indicative of the ED in a spatially-resolved manner. This can mean that multiple RX beams are used at 5007 to measure the ED at different sectors around the node 93. Then, it would be possible to report the ED for the different sectors around the node 93.

It would be possible that the request 4005 is indicative of such configuration of the measurement report 4010 in terms of frequency resolution and/or spatial resolution.

While in FIG. 7 a scenario is illustrated in which the node 93 is requested to measure and report on the ED, in other scenarios, alternatively or additionally, it would be possible that the node 92 is requested to measure and report on the ED on the open spectrum.

As a general rule, various scenarios are conceivable regarding how the node 91 makes use of the measurement report 4010. One option is illustrated in FIG. 8.

FIG. 8 is a signaling diagram of communication between multiple nodes. The signaling of FIG. 8 may commence directly following the signaling of FIG. 7.

At 5040, a beam configuration for an LBT procedure to be used at the node 91 is determined. The beam configuration can be optionally determined based on the measurement report 4010 received at 5010 (cf. FIG. 7). Alternatively or additionally, it would also be possible to measure the ED on the open spectrum at the node 91 itself; then, such local measurement may also be considered when determining the beam configuration at box 5040.

Then, at 5045, the node 91 attempts to access the open spectrum using an LBT procedure using the beam configuration as determined at box 5040. In the scenario of FIG. 8, the LBT procedure is successful and, accordingly, at 5047, the node 91 can transmit data 4020, e.g., to both nodes 92, 93 or only to the node 93 provided the measurement report 4010.

Above, one example has been described in connection with FIG. 8 on how to make use of the measurement report 4010. A further scenario regarding how the 91 can make use of the measurement report 4010 received at 5010 is illustrated in connection with FIG. 9. Such scenario according to FIG. 9 may be implemented in addition or as an alternative to the scenario FIG. 8.

FIG. 9 is a signaling diagram of communication between multiple nodes 91-93. The signaling of FIG. 9 may commence directly following the signaling of FIG. 7.

At box 5050, the node 91 determines a beam configuration for remote use. It is possible, albeit not mandatory that the beam configuration determined at box 5050 is based on the measurement report 4010 received from the node 93 at 5010 (cf. FIG. 7). More generally speaking, it is possible that the beam configuration is determined based on one or more decision criteria. Examples for such decision criteria are summarized below in table 3.

TABLE 3
Decision criteria for considering when determining the beam configuration
for an LBT procedure for accessing an open spectrum by the node
92. Multiple such decision criteria can be combined in various
examples. For example, a multi-decision path may be defined.

| Example | Brief description | Detailed description |
|---|---|---|
| A | Measurement report | It is possible that the measurement report |
| | received from | indicative of the ED is measured by another node |
| | another node | (e.g., node 93) is considered when determining |
| | | the beam configuration for a further (e.g., node 92). |
| B | Traffic density | The traffic density on the open spectrum can |
| | | be a quantity that is derived based on one or |
| | | more measurements. The traffic density can be |
| | | a quantity indicative of how many nodes are |
| | | currently attempting to access the open spectrum. |
| | | The traffic density may be determined based |
| | | on a number of UEs connected to one or more |
| | | BS of the RAN of the cellular NW (cf. FIG. 3). |
| | | The traffic density may be determined based |
| | | on beacons transmitted by nodes accessing |
| | | the open spectrum and indicative of these |
| | | nodes attempting to transmit the open spectrum. |
| | | Such beacons may reserve the open |
| | | spectrum for the transmitting nodes. |
| | | The traffic density may be determined based |
| | | on the ED measured by one or more nodes. |
| | | For example, it would be possible that the ED |
| | | is measured by the node 91 itself. It would also |
| | | be possible that the node 91 infers the traffic |
| | | density based on the measurement report received |
| | | from the node 93. |
| | | As a general rule, it would be possible that the |
| | | traffic density is considered in a spatially |
| | | resolved manner and/or a frequency resolved |
| | | manner when determining the beam configuration. |
| | | In particular, it would be possible to determine |
| | | a traffic density on the open spectrum that |
| | | is applicable to the spatial stream between the |
| | | node 92 and the node 91. For example, this |
| | | could include measuring the ED on a beam directed |
| | | towards the node 92. For example, this |
| | | could include considering one or more measurement |
| | | reports of nodes that are located close |
| | | to the node 92 or even from the node 92 itself. |
| | | To determine the spatially resolved traffic |
| | | density, it would be possible to take into account |
| | | the directions of RX beams used to measure |
| | | the ED on the open spectrum, where applicable. |
| | | It would also be possible to take into account |
| | | positions of connected devices within the |
| | | coverage area of the cellular NW, where applicable. |
| C | Device capability | It would be possible that the node 92 reports to |
| | | the node 91 a beamforming capability. Then, |
| | | the beam configuration can be determined in |
| | | accordance with the device capability of the |
| | | beamforming capability. For illustration, it |
| | | would be conceivable that the beamforming |
| | | capability specifies a maximum count of beams. |
| | | The beamforming capability could specify |
| | | which beams are available, e.g., in terms of |
| | | beam width, orientation, etc. The beamforming |
| | | capability could specify the number of antenna |
| | | panels, each antenna panel including a |
| | | respective antenna array. |
| D | Measurement report | Where a node - here, node 91 - determines |
| | received from | the beam configuration for a further node - |
| | further node | here, node 92 -, it would be possible to |
| | | consider a measurement report such as the |
| | | measurement report 4010 indicative of the ED on |
| | | the open spectrum measured by that further node. |
| | | I.e., in the illustrated example of FIG. 8, it would |
| | | be possible that the node 92 transmits a |
| | | measurement report 4010 to the node 91. |
| E | Local measurement | The node 91 determining the beam configuration |
| | | can also locally sense the ED on the open |
| | | spectrum. |
| F | Collision intensity | It would be possible to monitor how many |
| | | collisions occur when accessing the open |
| | | spectrum, over a certain time duration. Here, too |
| | | many collisions can be indicative of a trend of |
| | | underestimating the traffic density while too |
| | | few collisions can be indicative of a trend of |
| | | overestimating the traffic density. |

As will be appreciated from TAB. 3, along with time-varying conditions on the open spectrum, the underlying decision criteria may face changes. Accordingly, it would be possible to monitor for changes of the at least one decision criteria and then adjust the at least one beam configuration based on said monitoring. Thus, the beam configuration may be dynamically updated.

Then, at 5055, the determined beam configuration 4050 (e.g., implementing the beam configuration 200, cf. FIG. 5 and FIG. 6) is transmitted to the node 92 from the node 91. As a general rule, various options are available for implementing such transmission of the beam configuration 4050. Some examples are summarized in TAB. 4 below.

TABLE 4
Example implementations of the beam configuration 4050 transmitted at 5055.

| Example | Brief description | Detailed description |
|---|---|---|
| A | Relative beam width | For example, it would be possible that the |
| | | beam configuration 4050 is indicated by an |
| | | information element that is indicative of a beam |
| | | width of one or more beams specified by the |
| | | beam configuration. |
| | | The beam width could be relatively indicated, |
| | | e.g., with respect to a reference beam width. |
| | | The reference beam width may be specifically |
| | | assigned to the node 92. For example, where |
| | | multiple nodes are being provided with beam |
| | | configurations, these different nodes may be |
| | | associated with different reference beam |
| | | widths. |
| | | For instance, it could be specified that beams |
| | | should be used that have 80% of the maximum |
| | | available beam width. |
| B | Relative LBT angle | For example, it would be possible that the |
| | | beam configuration 4050 as indicated by an |
| | | information element that is indicative of a LBT |
| | | angle 209 to be implemented when performing |
| | | the LBT procedure. |
| | | For instance, a number varying between 0 and |
| | | 1 could be used, 1 corresponding to an |
| | | omnidirectional beam configuration and 0 |
| | | corresponding to the narrowest possible beam |
| | | configuration. |
| | | It could also be specified that beams should |
| | | attain a certain degree of spherical coverage, |
| | | like one fourth or one fifth or another fraction |
| | | of a sphere. |
| C | Subset of beams | It would be possible that the beam configuration |
| | | is indicated by an information element indicative |
| | | of a count of beams to be used during the LBT |
| | | procedure. |
| | | For instance, a relative indication could be |
| | | made with respect to the maximum count of |
| | | available beams. For example, if this |
| | | information element reads “0.5”, and 50% of all |
| | | available beams at the node 92 could be used. |
| | | For example, it could be specified that certain |
| | | beams of a codebook of beams should be |
| | | used. For instance, a bitmap may be used |
| | | where each entry of the bitmap either indicates |
| | | the respective beam to be activated or to be |
| | | deactivated. |
| D | Count of antenna | It would be possible to indicate that a count of |
| | panels | antenna panels to be used. This could be |
| | | indicated in absolute numbers. Also, an indication |
| | | in relative terms could be used. |
| E | Implicit indicator | It would be possible to set a 1 bit indicator and |
| | based on beam | a downlink transmission to a UE that is |
| | correspondence | transmitted on the specific beam. For instance, a 1 |
| | | bit indicator could be set in a SSB that is |
| | | transmitted on a respective transmit beam by a BS. |
| | | Then, based on beam correspondence, the UE |
| | | can judge to implement a directional beam |
| | | configuration limited to or centered with respect |
| | | to the RX beam obtained from beam correspondence |
| | | from the transmit beam used by the transmitting node. |
| F | Count of antenna | It would be possible to indicate the count of |
| | elements | antenna elements to be used. This could be an |
| | | indication in absolute numbers or in relative terms. |

To deliver the beam configuration 4050, various options are available. For example, it would be possible that the beam configuration 4050 is included as an information element in an SSB that is periodically broadcasted by the node 91. Typically, the SSB is part of an SSB burst that is repeatedly transmitted on multiple beams. Then, it would be possible that the SSB directed on a beam directed towards the node 92 includes an information element that is indicative of the beam configuration 4050 determined for that node 92, e.g., an information element carrying information as discussed in connection with TAB. 4. Such an implementation has the effect that the node 92—e.g., implemented by the UE 102—can read the beam configuration 4050 even before transitioning to the connected mode 301-302. I.e., it would be possible that the LBT procedure is used to then subsequently access the open spectrum to perform a random-access procedure to transition to the connected mode 301. To achieve such effects, it is not required in all scenarios that the beam configuration 4050 be included in the SSB. In another scenario, it would be possible that the beam configuration is associated with one or more SSBs that are periodically broadcasted by the node 91. This can pertain to a scenario in which a beam associated with an SSB of a respective burst is used to transmit the (then separate) information element that is indicative of the beam configuration 4050. For example, a separate, dedicated message may be used that is separate from the respective SSB. Such information element may be transmitted at a fixed temporal and/or frequency relationship with respect to the respective SSB transmitted on the same beam.

As a general rule, it would be possible that the beam configuration 4050 is transmitted on the open spectrum itself or on a dedicated spectrum (cf. FIG. 1).

The node 92, then receives the beam configuration 4050 at 5055 and, optionally, at box 5060, adjusts the beam configuration 4050. For instance, where the node 92 locally senses an increased ED on the open spectrum on a respective beam as indicated by the beam configuration 4050, the node 92 may decide to deviate from the beam configuration 4050 as transmitted at 5055. In other words, it would be possible to determine whether there is any difference in the local judgement on the beam confirmation 4050 and the beam information 4050 as indicated by the node 91.

At 5065, the node 92 performs the LBT procedure. For this, the beam configuration as determined at box 5060 is used; which can be based on the beam configuration 4050 received at 5055. For example, if the node 91 configures an omnidirectional beam configuration 4050 (and this beam configuration is not subsequently adjusted by the node 92), then the node 92 can use the omnidirectional beam configuration at box 5065. Conversely, if the node 91 determines and signals a unidirectional beam configuration 4050 (and if this beam configuration is not adjusted afterwards), then the node 92 can use a single RX beam for monitoring the open spectrum at 5065 when performing the LBT procedure.

Then, at 5070—in case the LBT procedure executed at 5065 is successful—the node 92 transmits data 4020, in the illustrated scenario to the node 91. It would also be possible that the node 92 transmits the data 4020 to another node, e.g., the node 93 (not illustrated in FIG. 9).

As will be appreciated, the scenario of FIG. 9 can be applicable to multiple use cases. For example, the data 4020 transmitted at 5070 could be associated with control data, e.g., as part of a random-access procedure to transition from operating in the idle mode 303 to the connected mode 301. It would also be possible that the data 4020 transmitted at 5070 is payload data transmitted along a data connection 189 while the node 92 operates in the connected mode 301.

Summarizing, FIG. 9 describes a scenario in which the node 91, e.g., a BS 101 of RAN of a cellular NW, has no prior knowledge of the traffic density on the open spectrum or potentially interfering devices. Thus, to be able to determine the beam configuration at box 5050, it is possible that the node 91 performs an LBT procedure using an omnidirectional beam configuration before transmitting SSB bursts. After some time, the node 91 has obtained a measure of the traffic density on the open spectrum within its coverage area and can decide upon the preferred beam configuration for the LBT procedure. Then, the beam configuration as determined at box 5050 could be broadcasted in the SSBs as part of the system information, e.g., encoded in a physical broadcast channel. Here, the particular beam configuration determined at box 5050 can be per transmit beam of the node 91 used to broadcast the SSBs. In other words, the node 91 can configure different beam configurations on different TX beams, e.g., beams used for the transmission of the SSBs. This is due to the traffic density on the open spectrum potentially varying geographically. It is not required in all scenarios that the determined beam configuration is included in the SSBs. For example, alternatively, it would be possible that the beam configuration is multiplexed (e.g., in time domain and/or frequency domain and/or in coded domain): this means that additional resources can be added outside the SSBs but transmitted within the same TX beam.

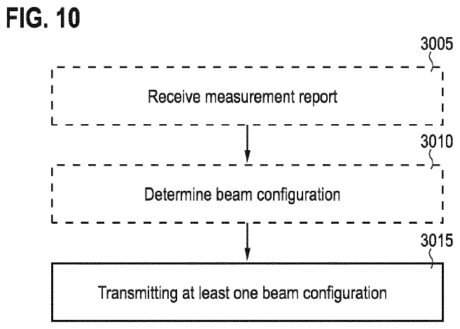

FIG. 10 is a flowchart of a method according to various examples. The method of FIG. 10 can be executed by a node of a wireless communication NW. For instance, the method of FIG. 10 could be executed by the node 91. For example, it would be possible that the method of FIG. 10 is executed by a BS, e.g., the BS 101 (cf. FIG. 2). More specifically, it would be possible that the method is executed by the processor 1011 upon loading and executing program code from the memory 1015. Optional boxes are labeled with dashed lines.

At box 3005, a measurement report is received from another node. The measurement report is indicative of an ED on the open spectrum. Box 3005 can thus implement 5010 of FIG. 7.

At box 3010, it is possible to determine a beam configuration or multiple beam configurations. For example, it would be possible to determine a single beam configuration for a single further node or it would be possible to determine multiple beam configurations for multiple further nodes. Where multiple beam configurations are determined, these multiple beam configurations can differ from each other. When determining the beam configurations, one or more decision criteria as described above in connection with TAB. 3 can be taken into account. In alternative examples, it would be possible that the beam configuration is fixedly predefined.

For instance, at box 3010, a beam configuration can be determined that is used by the node determining the beam configuration, as well as configured for one or more further nodes.

The beam configuration can be determined at box 3010 based on one or more decision criteria, cf. TAB. 3. An example would be an estimate of the traffic density on the open spectrum. As a general rule, to estimate the traffic density, there are multiple options available: firstly, for devices centrally scheduled by a NW to which the node executing box 3010 belongs, it would be possible to consider the count of connected devices, e.g., in a specific cell for a cellular NW or connected to a specific BS. Connected devices are such devices that operate in the connected mode, i.e., for which mobility is tracked. For other devices not centrally scheduled or devices in other cells of the cellular NW, it would be possible to estimate the traffic density based on the level of the ED that has been measured, e.g., using multiple RX beams. In addition, alternatively or additionally, a collision intensity can be considered, i.e., a measure of how often of collisions are observed accessing the open spectrum.

Various techniques are based on the finding that for a 3GPP cellular NW it is usually the case that the BS initiates the transmission, i.e., the BS starts with transmitting an SSB burst for initial access. First, the BS has an initial estimate of the traffic density on the open spectrum in its cell through the number of connected devices. In addition, the BS can also perform an LBT procedure to estimate the traffic density caused by nearby non-3GPP devices or 3GPP devices connected to other nodes. Therefore, it is feasible for the BS to make a judgment on the overall traffic density and the coverage area and based on this configure the UEs with the proper beam configuration for the LBT procedure.

Then, at box 3015, one or more beam configurations for an LBT procedure are transmitted to one or more further nodes. These are the beam configurations that can be determined at box 3010. Options with respect to information indicated by the beam configurations have been discussed above in connection with TAB. 4.

For example, it would be possible to transmit multiple different beam configurations to multiple further nodes. For instance, the traffic density could be determined in a spatially-resolved manner and then, for different sectors in the neighborhood of the respective node, different beam configurations may be determined based on the spatially-resolved traffic density. In another scenario, one and the same beam configuration could be reused for multiple further nodes, even if they are located at different positions.

Such techniques enable mitigation of the issues of omnidirectional beam configurations for LBT procedures resulting in the exposed node problem and a long gap between uplink communication and downlink communication due to the LBT procedure, as well as directional beam configurations for LBT procedures, resulting in the hidden node problem. This is achieved by being able to dynamically configure one or more further nodes with either omnidirectional beam configurations or directional beam configurations based on a traffic density observed on the open spectrum, using appropriate control signaling. In particular, it is possible to take into account a spatially-varying access to the open spectrum, in particular for scenarios in which spatial multiplexing is used.

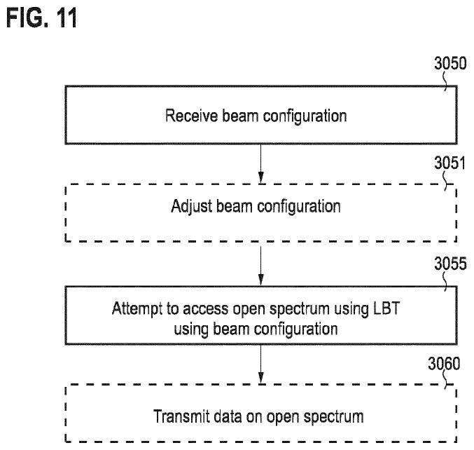

FIG. 11 is a flowchart of a method according to various examples. The method of FIG. 11 can be executed by a node of a communications NW. For instance, the method of FIG. 11 could be executed by the node 92. For example, it would be possible that the method of FIG. 11 is executed by a UE, e.g., the UE 102 (cf. FIG. 2). More specifically, it would be possible that the method is executed by the processor 1021 upon loading and executing program code from the memory 1025. Optional boxes are labeled with dashed lines.

At box 3050, a beam configuration is received from a further node. Box 3050 is, thus, interrelated with box 3015 (cf. FIG. 10). Box 3050 thus implements FIG. 9, 5055. To receive the beam configuration, it would be possible to monitor a control channel at certain predefined time-frequency resources. For instance, these time-frequency resources may correspond to SSB bursts. Respective information elements may be included in or interleaved with SSBs.

At optional box 3051, the beam configuration as received at box 3050 can be optionally adjusted. This can be based on local measurements, e.g., of the ED. Also, cf. FIG. 9: 5060.

Then, using the beam configuration previously received, an attempt to access the open spectrum using an LBT procedure is made, at box 3055. Thus, one or more RX beams may be activated, e.g., in a beam sweep, to sense the ED on the open spectrum. Depending on the ED, it can be judged that the traffic density is high or low, and it can be judged that access to the open spectrum is possible or not. Depending on this judgment, it is possible that box 3060 is executed, i.e., the access to the open spectrum is executed and data is transmitted on the open spectrum.

While in FIG. 11 a scenario has been illustrated in which the beam configuration received at box 3050 is used to attempt to access the open spectrum using a LBT procedure at box 3055, it would alternatively or additionally be possible that the beam configuration as used in connection with the transmission of data at box 3060.

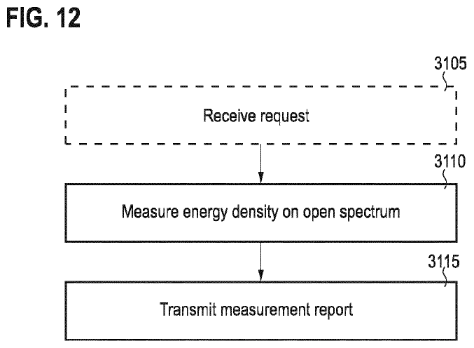

FIG. 12 is a flowchart of a method according to various examples. The method of FIG. 12 can be executed by a node of a wireless communication NW. For instance, the method of FIG. 12 could be executed by the node 92 and/or the node 93. For example, it would be possible that the method of FIG. 12 is executed by a UE, e.g., the UE 102 (cf. FIG. 2). The method of FIG. 12 can be executed while the UE operates in the connected mode 301-302. More specifically, it would be possible that the method is executed by the processor 1021 upon loading and executing program code from the memory 1025. Optional boxes are labeled with dashed lines.

At optional box 3105, a request for a measurement report is received, the request being indicative of the measurement report including an indicator indicative of the ED measured on the open spectrum.

Accordingly, at box 3110, the ED on the open spectrum is measured. At box 3115, the measurement report is transmitted, the measurement report being indicative of the ED having been measured. For instance, a separate measurement report may be used; or a measurement report may be used that also includes other measurements, e.g., RSRP and/or SINR. Radio Resource Control signaling may be used.

The measurement report can be transmitted at box 3115. The measurement report can be transmitted to the same node from which the request has been received at box 3105. Box 3115 is inter-related with box 3005 (cf. FIG. 10).

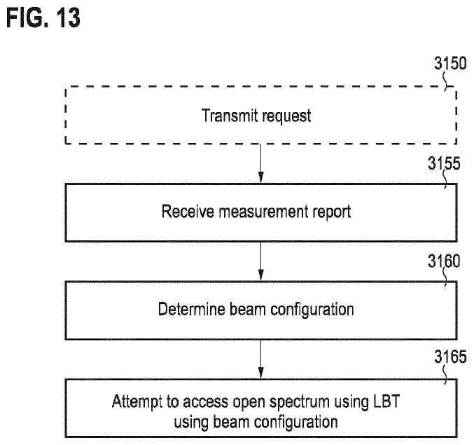

FIG. 13 is a flowchart of a method according to various examples. The method of FIG. 13 can be executed by a node of a communications NW. For instance, the method of FIG. 13 could be executed by the node 91. For example, it would be possible that the method of FIG. 13 is executed by a BS, e.g., the BS 101 (cf. FIG. 2). More specifically, it would be possible that the method is executed by the processor 1011 upon loading and executing program code from the memory 1015. Optional boxes are labeled with dashed lines.

At box 3150, it is optionally possible to transmit a request for a measurement report being indicative of a measured ED to one or more further nodes. Box 3150 is interrelated with box 3105 (cf. FIG. 12). For instance, such a request may be broadcasted. For instance, all further nodes in the neighborhood may be requested to provide the measurement report.

At box 3155, the measurement report is received. It would be possible that multiple measurement reports are received from multiple further nodes. The one or more measurement reports are indicative of an ED on the open spectrum as measured at the one or more further nodes. Box 3155 is inter-related with box 3115 (cf. FIG. 12).

Then, at box 3160, a beam configuration for an LBT procedure is determined based on the one or more measurement reports as previously received at box 3155.

At the determining of box 3160, it would be possible to take into account further decision criteria for determining the beam configuration, cf. TAB. 3. For example, it would be possible to perform a local measurement of the ED.

Then, at optional box 3165, an attempt is made to access the open spectrum by using an LBT procedure using the beam configuration as previously determined at box 3160. As a general rule, alternatively or additionally to determining a beam configuration at box 3160 for local use, it would be possible that the beam configuration as determined at box 3160 is for remote use, e.g., as discussed in connection with FIG. 10.

Summarizing, techniques have been described which enable NW-configuration of the beam configuration for an LBT procedure, e.g., selecting between an omnidirectional beam configuration and a directional or even a unidirectional beam configuration. Thereby, a balance between the exposed node problem and the hidden node problem can be achieved. For example, a BS including a scheduler to allocate resources on the open spectrum can initiate transmissions in the open spectrum by using estimations of the traffic density on the open spectrum. The BS can dynamically configure multiple UEs—e.g., operating in a connected mode or in an idle mode—individually with a tailored beam configuration, e.g., an omnidirectional beam configuration or a directional beam configuration. UE-specific or position-specific beam configurations can be used.

Such signaling to configure the UE with a beam configuration for use in an LBT procedure can be communicated for initial access and, here, included in or associated with SSBs, e.g., encoded in a physical broadcast channel. It would also be possible to transmit a respective information element in a time/frequency multiplexed manner with respect to SSBs. Such signaling can indicate the beams and/or the beam width and/or the number of antenna elements and/or the number of panels that the receiving also used for the LBT procedure.

In a further example, it has been described how a node can measure and report the ED on the open spectrum. A respective measurement report may be multiplexed with the further measurement report, e.g., for RSRP or SINR.

By selecting an appropriate beam configuration of the LBT procedure based on a traffic level on the open spectrum, it is possible to improve the LBT procedure. False positive outcomes and false negative outcomes of the LBT procedure can be reduced.

Such beam configuration can be, in particular, included in the SSB transmissions and then be used for initial access of a UE to a RAN of a cellular NW. Different beam configurations can be used for different spatial regions around a BS, considering that the traffic density varies geographically.

One or more nodes can report the sensed level of the ED, e.g., when operating in a connected mode with respect to a cellular NW. Then, the beam selection at the BS can be assisted. This can be helpful for high operating frequencies, e.g., in a 60 GHz band.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustration, various examples have been described in connection with accessing the open spectrum to communicate uplink data from the UE to a RAN of a cellular NW. As a general rule, similar techniques described herein may also be applied to other scenarios, e.g., sidelink communication between two UEs connected or connectable to the RAN.

For further illustration, various examples have been described with respect to the CCA procedure implemented by an LBT procedure. As a general rule, it would be possible to employ techniques as described herein for determining a beam configuration for other kinds and types of CCA procedures.

Further, various examples have been described with respect to the beam configuration being used for determining the beam configuration for the LBT procedure. As a general rule, it would be possible to employ such techniques as described herein with respect to determining a beam configuration for general beam switching during an ongoing data communication. For instance, it would be possible that a base station determines the beam configuration (e.g., the particular beams and/or the direction) for transmitting or receiving data on the open spectrum.

For still further illustration, various examples have been described according to which the beam configuration is transmitted in relationship with SSBs. As a general rule, the beam configuration may also be transmitted by means of Layer1/Layer2/Layer3 signaling using physical signals, PDCCH/PUCCH, PDSCH/PUSCH, etc. The transmissions of a beam configuration message does not need to be contemporaneous with SSB transmissions.

For still further illustration, various examples have been described in which a node provides a measurement report indicative of the ED, to thereby enable a further node to determine a beam configuration for accessing the open spectrum, e.g., for an LBT procedure. ED is one example of a type of report from which a traffic density on the open spectrum can be estimated or inferred. Thus, it would be possible to provide a measurement report indicative of another measured quantity and to determine the beam configuration based on this measured quantity. Other measured quantities include RSRP or Received Signal Strength Indicator (RSSI).

1. A method of operating a first node of a communications network, the method comprising:
transmitting, to at least one second node, at least one beam configuration of a listen-before-talk procedure for accessing an open spectrum by the at least one second node.

2. The method of claim 1,
wherein the at least one beam configuration is selected from the group comprising: a directional beam configuration, a unidirectional beam configuration, a multidirectional beam configuration, and an omnidirectional beam configuration.

3. The method of claim 1,
wherein the at least one beam configuration is indicative of a subset of beams of a group of beams.

4. The method of claim 1,
wherein the at least one beam configuration is indicated by an information element indicative of a beam width of one or more beams with respect to a reference beam width associated with the at least one second node.

5. The method of claim 1,
wherein the at least one beam configuration is indicated by an information element indicative of a count of antenna panels.

6. The method of claim 1,
wherein the at least one beam configuration is determined based on at least one decision criterion,
wherein the at least one decision criterion comprises a measurement report received from at least one of the at least one second node or a third node the measurement report being indicative of an energy on the open spectrum.

7. The method of claim 1,
wherein the at least one beam configuration is determined based on at least one decision criterion,
wherein the at least one decision criterion comprises a spatially resolved traffic density on the open spectrum.

8. The method of claim 7, further comprising:
determining the spatially resolved traffic density based on at least one of a number of wireless communication devices connected to one or more access nodes of the communications network, an energy on the open spectrum, or measurement reports received from one or more further nodes of the communications network.

9. The method of claim 1,
wherein the at least one beam configuration is determined based on at least one decision criterion,
wherein the method further comprises:
monitoring for changes of the at least one decision criterion,
adjusting the at least one beam configuration based on said monitoring, and
transmitting at least one adjusted beam configuration upon said adjusting.

10. The method of claim 1,
wherein the at least one beam configuration is transmitted to multiple
second nodes that are located at different positions with respect to the first node.

11. The method of claim 1,
wherein the at least one beam configuration comprises multiple beam configurations that are different from each other,
wherein different beam configurations of the multiple beam configurations are transmitted to multiple second nodes that are located at different positions with respect to the first node.

12. The method of claim 1,
wherein the at least one beam configuration is included in or associated with one or more synchronization signal blocks periodically broadcasted by the first node.

13. A method of operating a second node, the method comprising:
receiving, from a first node of a communications network, a beam configuration of a listen-before-talk procedure for accessing an open spectrum, and
attempting to access the open spectrum using the listen-before-talk procedure using the beam configuration.

14. The method of claim 13, further comprising:
measuring an energy on the open spectrum,
adjusting the beam configuration based on said measuring.

15-18. (canceled)

19. A method of operating a first node of a communications network, the method comprising
receiving, from at least one second node, a measurement report indicative of an energy on an open spectrum measured by the at least one second node,
determining a beam configuration for a listen-before-talk procedure for accessing the open spectrum based on the measurement report, and
attempting to access the open spectrum using the listen-before-talk procedure using the beam configuration.

20. The method of claim 19, further comprising:
measuring the energy on the open spectrum,
wherein the beam configuration for the listen-before-talk procedure for accessing the open spectrum is determined further based on the measured energy.

21. The method of claim 19, further comprising
requesting, from the at least one second node, the measurement report indicative of the energy.
